(19) United States
(12) Patent Application Publication
(10) Pub. No.: US 2008/0156591 A1
(43) Pub. Date: Jul. 3, 2008

(54) Elevator Car Position Detection

(76) Inventor: Michael J. Tracey, Cromwell, CT (US)

Correspondence Address: CARLSON GASKEY & OLDS, 400 W MAPLE STE 350, BIRMINGHAM, MI, 48009, US

(21) Appl. No.: 11/912,180

(22) PCT Filed: Jun. 1, 2005
(86) PCT No.: PCT/US05/19205

§ 371 Date: Oct. 22, 2007

(51) Int. Cl. B66B 3/00

(52) U.S. Cl. 187/394

(57) ABSTRACT

A device (40) for providing information regarding the position of an elevator car door (34) relative to a hoistway door (30) includes a reflector (42) supported on the hoistway door (30). A sensor (44) supported on an elevator car door (34) includes a plurality of sensing elements (46-50) for emitting radiation toward the reflector (42). Received radiation reflected from the reflector (42) provides an indication of the position of the car door (34) relative to the hoistway door (30).

### 1. FIELD OF THE INVENTION

This invention generally relates to elevator systems. More particularly, this invention relates to position detection within elevator systems.

### 2. DESCRIPTION OF THE RELATED ART

Elevator systems typically include a car that moves vertically along a hoistway to carry passengers, cargo or both between various levels of a building. Typical arrangements allow an elevator car to service a plurality of floor levels within a building. The car doors preferably are controlled so that they open only when the car is within an acceptable distance from a final resting point at a landing according to local codes.

Various arrangements are known for controlling elevator door operation to ensure that the car is within the appropriate distance of a landing. One example arrangement includes a sequence of optical or inductive sensors and vanes that cooperate to provide information regarding the elevator car being within the zone where the car doors can be opened. A significant shortcoming of such arrangements is that the vane system is typically installed on the elevator guide rails at or near each landing. Installation of such a vane system requires precise adjustment relative to landing doors to ensure that the detected elevator car position is accurate. Accurate information is typically required because the same vane system is often used for leveling, position system corrections and initialization, advanced door opening control and elevator car slowdowns near a landing. Additionally, building settling over time or changes in elevator system components caused by rope stretching, for example, alters the accuracy of such a vane system. Periodic inspection and maintenance, therefore, is required.

There is a need for an improved arrangement for detecting the position of an elevator car within a hoistway and, in particular, for determining when a car is appropriately positioned relative to a landing for operating the car doors. It would be beneficial to have such a system that does not suffer from the drawbacks associated with rail-mounted vane and sensor systems.

This invention addresses those needs.

### SUMMARY OF THE INVENTION

An exemplary disclosed device for determining a position of a door in an elevator system includes a reflector that is mountable on one of a hoistway door or an elevator car door. A sensor is mountable on the other of the elevator car door or the hoistway door. The sensor has an emitter portion that emits radiation in a direction toward the reflector. A receiver portion of the sensor receives reflected radiation from the reflector when the sensor is aligned with the reflector.

In one example, the sensor provides a signal indicative of the received, reflected radiation for providing an indication of a position of the corresponding door.

One example includes using radiation from within the range of electromagnetic radiation including light, infrared radiation and microwave radiation. One disclosed example includes optical sensors that utilize light as the emitted and reflected radiation.

The disclosed example avoids the difficulties associated with mounting position sensor components on guide rails. This provides a more consistently reliable system that is more economical to install.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of an elevator system including a position detector arrangement designed according to an embodiment of this invention.

FIG. 2 is a side view schematically showing selected portions of an example sensor device designed according to an embodiment of this invention.

FIG. 3 schematically shows one feature of an example embodiment.

### DETAILED DESCRIPTION OF THE PREFERRED EMBODIMENTS

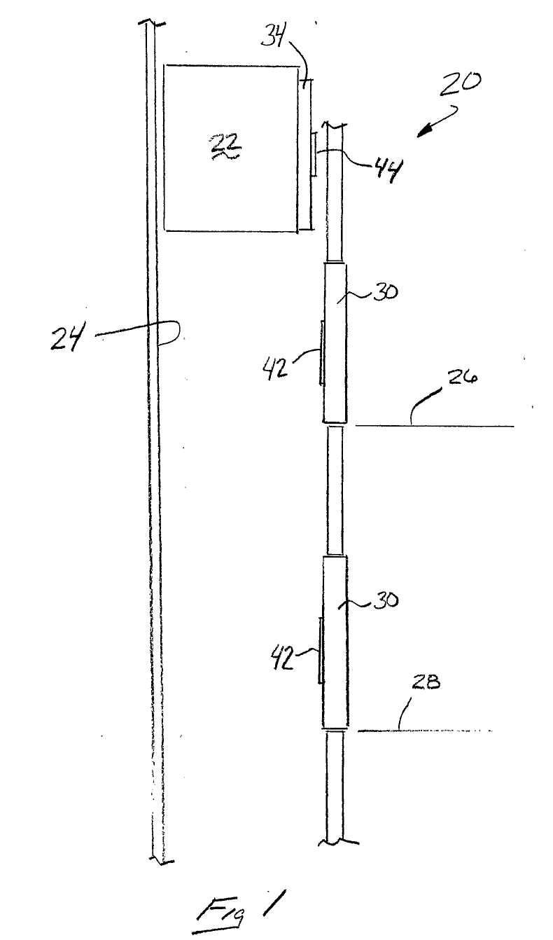

FIG. 1 schematically shows selected portions of an elevator system 20. An elevator car 22 moves along a hoistway 24 in a generally known manner. The elevator car 22 can carry passengers, cargo or both between various levels in a building. Landings 26 and 28 represent floors or levels within a building where access to the elevator car 22 is available. Hoistway doors 30 selectively close off the hoistway 24 from the landings 26 and 28. The elevator car 22 includes at least one car door 34 that cooperates with the hoistway door 30 at an appropriate landing in a known manner so that the doors open and close together.

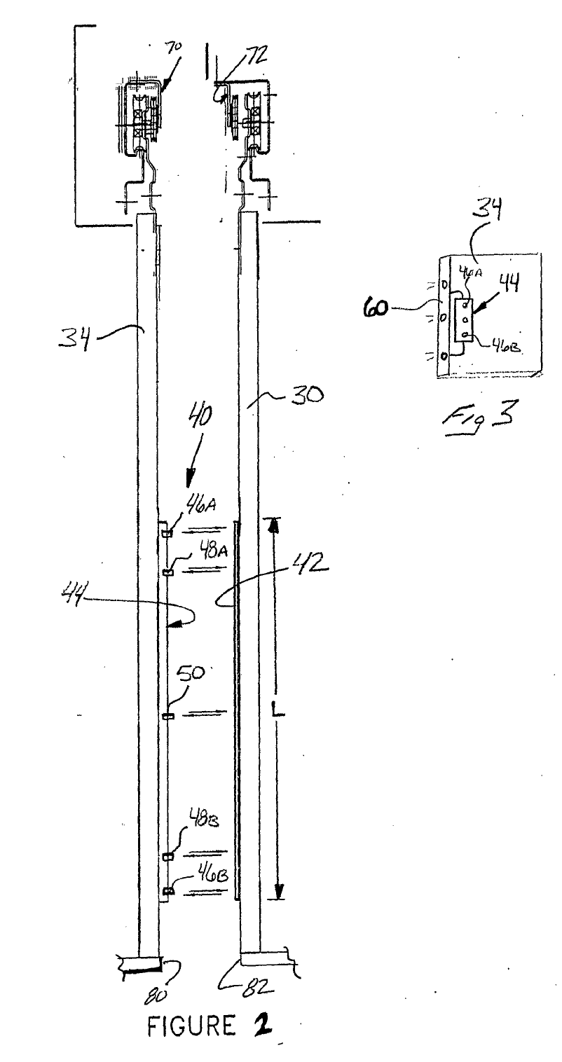

As best appreciated from FIG. 2, the example elevator system 20 includes a device 40 for detecting a position of the elevator car 22 along the hoistway 24. In particular, the illustrated device 40 provides information regarding a position of the elevator car door 34 relative to a hoistway door 30. As the door position relative to the elevator car frame is known, door position information provides an indication of elevator car position.

In the illustrated example, the device 40 includes a reflector 42 that is supported in a fixed position on the hoistway door 30 in this example. As can be appreciated from FIG. 1, each hoistway door 30 has a corresponding reflector 42. Setting the position of each reflector 42 on the hoistway door 30 preferably is controlled so that a vertical position of the reflector 42 relative to the hoistway 24 or at least the corresponding landing is known.

The device 40 also includes a sensor 44 that interacts with a reflector 42 when the car door 34 is appropriately positioned relative to the corresponding hoistway door 30. For example, when the elevator car 22 approaches the landing 26, the sensor 44 interacts with the reflector 42 on the hoistway door 30 at the landing 26.

In the illustrated example, the sensor 44 is fixed to the car door 34 and includes a plurality of sensor elements 46, 48 and 50. Each sensor element includes an emitter portion that emits radiation toward the reflector 42. Each sensor element also includes a receiver portion that receives reflected radiation from the reflector 42.

In one example, the radiation is selected from the range of electromagnetic radiation that includes light, infrared radiation and microwave radiation. One particular example includes optical sensor elements and the emitted and reflected radiation comprises light.

In the example of FIG. 2, sets of the sensor elements provide information regarding the position of the door 34 relative to the door 30 within various ranges of interest. For example, a combination of signals indicating the received, reflected radiation from the sensor elements 46A and 46B provides information regarding the position of the car door 34 (and, therefore, the car 22) within a first range. The set of sensors 48A and 48B provide position information within a second range. The sensor 50 provides position information within a third, wider range.

In one example, the sensor 50 provides position information within a range corresponding to a leveling zone within which powered operation of the car door 34 may be initiated. In this example the leveling zone extends from a final car leveling position in two directions a distance corresponding to one-half the length of the reflector 42. The sensor element 50 can emit radiation toward the reflector 42 and receive radiation reflected off the reflector 42 at any position within a range that corresponds to the entire length L of the reflector 42. In one example, the sensor element 50 provides position feedback information within a leveling zone that is 300 millimeters in height.

The sets of sensor elements 46A, 46B, 48A and 48B cooperate to provide a range of position information corresponding to an inner landing zone. In one example, the sensor elements 48A and 48B combined with the sensors 46A and 46B provide position information that is accurate to within 75 millimeters. Spacing the sensor elements 48A and 46A by 75 mm and spacing the sensor elements 48B and 46B by the same amount provides the +/−75 mm range. An inner landing zone range is useful to control car movement outside of this range based on whether the doors are closed. In one example, the car will not be moved beyond the inner landing zone if the doors are open.

One feature of the example device 40 is that the reflector 42 has a length L that is long enough to allow all of the sensor elements 46-50 to simultaneously receive radiation reflected from the reflector 42.

Providing various ranges for position information allows a controller 52 to communicate with an elevator system controller, for example, regarding elevator car position along the hoistway 24 or relative to a particular hoistway door 30 to allow for the desired level of door control and car position control. In one example, the controller 52 is capable of utilizing a variety of position information based on signals from the different example sensor elements to achieve the desired level of control of door movement or car position, for example.

Referring to FIG. 3, an example elevator door 34 includes a door reversal position detecting arrangement 60 that operates in a known manner to detect when an individual or an object is in the pathway of a door moving into a closed position. In this example, the sensor 44 is supported on the car door 34 and associated with the door reversal detection device 60. This example arrangement provides the advantage of utilizing power supplied to the door reversal device for powering the sensor 44. In one example, the structure utilized for mounting the door reversal sensing device 60 also provides structure for mounting the sensor 44 on the car door 34. One advantage to the disclosed example is that it does not require additional wiring or power connections on an elevator car door 34 apart from a simple connection with hardware that already exists for providing a door reversal sensing function.

The example embodiment of FIG. 2 includes positioning the reflector 42 and the sensor 44 directly on the door panels of hoistway door 30 and the car door 34, respectively. Another example includes supporting at least part of the sensor 44 on a rail 70 or a portion of the elevator car frame near the top of the door 34. In the same example, at least some of the reflector 42 is strategically positioned on a hoistway door rail 72 or another portion of the hoistway door frame near the top of the hoistway door 30.

Another example includes positioning at least a portion of the sensor 44 on a sill member 80 near a bottom of the elevator car door 34. In the same example, at least a portion of the reflector 42 is positioned on a sill member 82 near a bottom of the hoistway door 30.

Accordingly, supporting the reflector 42 and the sensor 44 on the doors does not necessarily require the entire sensor or reflector to be mounted on a door panel of the doors. Other frame members adjacent the door panels are considered part of the door for some example embodiments. One advantage to using an arrangement as shown in the example of FIG. 2 is that various ranges of position information are available utilizing a single reflector, for example. Some or all of the example components may be supported on another structure member associated with the doors but not on the door panels, themselves.

A significant advantage to the disclosed arrangement is that the fixed position of the sensor 44 and the fixed position of the reflector 42 relative to the corresponding doors eliminates dependencies on building settlement, rail positions or rope stretching when determining a position of the car door 34 relative to the hoistway door 30. The disclosed example, therefore, eliminates the maintenance and adjustment procedures that were involved with conventional arrangements, which has been undesirable from a cost standpoint, for example.

Another advantage to the disclosed example is that it allows for relatively easy installation from a landing adjacent the hoistway. Any maintenance or adjustment can also be made from a landing and does not require an individual to enter the hoistway, which has been required with conventional arrangements that relied upon vanes secured to the guide rails.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. A device for determining a position of a door in an elevator system, comprising:
a reflector that is mountable on one of a hoistway door or an elevator car door; and
a sensor that is mountable on the other of the elevator car door or the hoistway door, the sensor comprising a plurality of sensor elements spaced apart in a selected arrangement, the sensor comprising an emitter portion configured to emit radiation in a direction toward the reflector and each sensor element comprising at least a receiver portion configured to receive reflected radiation from the reflector when the sensor is aligned with the reflector, at least a first one of the sensor elements providing position information within a first range and at least a second one of the sensor elements providing position information within a second, smaller range.

22. The device of claim 21, wherein the sensor provides a signal indicative of the received, reflected radiation for providing an indication of a position of the corresponding door.

23. The device of claim 21, wherein the radiation emitted by the sensor emitter portion comprises light.

24. The device of claim 21, wherein the radiation emitted by the sensor emitter portion comprises one of infrared radiation or microwave radiation.

25. The device of claim 21, wherein the first range is up to approximately four times greater than the second range.

26. The device of claim 25, wherein the first range is approximately 300 mm and the second range is approximately 75 mm.

27. The device of claim 21, wherein the first range corresponds to a leveling zone for an elevator car and the second range corresponds to an inner landing zone.

28. The device of claim 27, comprising a controller configured to permit initiating powered movement of the elevator car door when the sensor indicates an associated elevator car is in the leveling zone and to prevent movement of the elevator car out of the inner landing zone if the elevator car door is open.

29. The device of claim 21, wherein the reflector has a dimension that allows every one of the sensor elements to simultaneously receive reflected radiation from the reflector.

30. The device of claim 21, wherein at least two of the sensor elements cooperate to provide the position information within the second range.

31. The device of claim 21, wherein the first sensor element is centrally located on the sensor, a first set of other ones of the sensor elements are on one side of the first sensor element, the sensor elements of the first set are spaced apart a distance corresponding to the second range, a second set of other ones of the sensor elements are on an opposite side of the first sensor element, the sensor elements of the second set are spaced apart the distance corresponding to the second range and wherein the first and second sets cooperate to provide the position information in the second range.

32. The device of claim 21, wherein each sensor element comprises an emitter portion.

33. An elevator door assembly, comprising:
at least one hoistway door;
at least one elevator car door;
at least one reflector supported on one of the hoistway door or the elevator car door; and
a sensor supported on the other of the elevator car door or the hoistway door, the sensor comprising a plurality of sensor elements spaced apart in a selected arrangement, the sensor comprising an emitter portion configured to emit radiation in a direction toward the reflector, each sensor element comprising at least a receiver portion configured to receive reflected radiation from the reflector when the sensor is aligned with the reflector, at least a first one of the sensor elements providing position information within a first range and at least a second one of the sensor elements providing position information within a second, smaller range.

34. The assembly of claim 33, wherein the sensor is at least partially supported on a door panel of the elevator car door and the reflector is at least partially supported on a door panel of the hoistway door.

35. The assembly of claim 33, wherein the sensor is at least partially supported on one of a rail member or a sill member of the elevator car door and the reflector is at least partially supported on a corresponding one of a rail member or a sill member of the hoistway door.

36. The assembly of claim 33, wherein the sensor provides a signal indicative of the received, reflected radiation for providing an indication of a position of the elevator car door relative to the hoistway door or an indication of a position of an associated elevator car.

37. The assembly of claim 33, wherein the first range corresponds to a leveling zone for an elevator car and the second range corresponds to an inner landing zone.

38. The assembly of claim 33, comprising
a door reversal position detecting arrangement associated with the elevator car door and
wherein the sensor is supported by a structure utilized for mounting the door reversal detecting arrangement and the sensor utilizes power supplied to the door reversal position detecting arrangement.

39. The assembly of claim 33, wherein the first sensor element is centrally located on the sensor, a first set of other ones of the sensor elements are on one side of the first sensor element, the sensor elements of the first set are spaced apart a distance corresponding to the second range, a second set of other ones of the sensor elements are on an opposite side of the first sensor element, the sensor elements of the second set are spaced apart the distance corresponding to the second range and wherein the first and second sets cooperate to provide the position information in the second range.

40. The assembly of claim 33, wherein each sensor element comprises an emitter portion.
